(19) United States
(12) Patent Application Publication
(10) Pub. No.: US 2026/0280063 A1
(43) Pub. Date: Sep. 17, 2026

(54) SEALED BUS BAR AND METHOD FOR PRODUCING THE SEALED BUS BAR

(71) Applicant: ENNOVI ADVANCED ENGINEERING SOLUTIONS GERMANY GMBH, Heilbronn (DE)

(72) Inventor: Dirk ROTZSCHE, Koblenz (DE)

(21) Appl. No.: 19/146,334

(22) PCT Filed: Dec. 18, 2023
(86) PCT No.: PCT/EP2023/086327

§ 371 Date: Jul. 8, 2025

(30) Foreign Application Priority Data
Feb. 8, 2023 (DE) 10 2023 102 992.4

(51) Int. Cl. H01M 50/526; H01M 50/522; H01M 50/524

(52) U.S. Cl. CPC H01M 50/526; H01M 50/522; H01M 50/524

(57) ABSTRACT

A method for manufacturing a sealed bus bar, in which firstly a metal bus bar having a plurality of bus bar connections is provided and then one or more separate seals or sealing means are arranged at predetermined positions on the metal bus bar. Directly after the arrangement step, the metal bus bar is over-moulded with a plastic overmoulding around the regions of the sealing means by way of an injection moulding device such that the sealing means is completely overmoulded.

### RELATED APPLICATIONS

This application claims priority to and is a 35 U.S.C. § 371 national phase application of PCT/EP2023/086327, filed Dec. 18, 2023, and claims priority to German Patent Application No. 10 2023 102 992.4, filed Feb. 8, 2023, the entire contents of each of which are incorporated herein by reference in their entirety.

### FIELD

The present disclosure relates to a sealed bus bar and a method for manufacturing the sealed bus bar.

### BACKGROUND

During manufacture of a sealed bus bar, a sealing means is arranged around regions of the bus bar and is typically overmoulded with a plastic material. However, before the sealing means can be overmoulded, the sealing means must be fixed to the bus bar as intended to ensure the sealing function. For this purpose, the sealing means is heated and/or cooled and/or bonded, for example.

However, these, in particular successive, process steps are very complex and time-consuming and thus costly.

### BRIEF SUMMARY

The present disclosure provides a sealed bus bar and a method for manufacturing a sealed bus bar, in which the complexity and number of manufacturing steps are reduced and the method for manufacturing is optimized.

According to the present disclosure, a method for manufacturing a sealed bus bar is proposed, in which firstly a metal, in particular electrically conductive, bus bar having a plurality of bus bar connections is provided and then one or more separate seals or sealing means are arranged at predetermined positions on the metal bus bar. Directly after the arrangement step, the metal bus bar is overmoulded with a plastic overmoulding around the regions of the sealing means by way of or by means of an injection moulding device such that the sealing means is completely overmoulded.

The advantage of this is that, due to the reduction in method steps to be performed prior to the overmoulding, the cycle time of the manufacturing is shortened. In particular, omitting heating and cooling of the sealing means before overmoulding it with the plastic overmoulding results in a reduction in the energy consumed and the thermal load on the component. The plastic overmoulding is preferably manufactured by means of insert moulding.

In a preferred embodiment of the method, the sealing means is a shrink tube and/or a shrink film. During overmoulding, the shrink tube is heated by a thermal energy of the plastic overmoulding, in particular a melt of the plastic overmoulding, such that the shrink tube shrinks until it rests on the metal bus bar in a sealing manner. In this way, a high sealing effect is achieved or the sealing effect is improved. Moreover, in contrast to a rubber sealing ring, special requirements for the geometry or shape of the metal bus bar do not have to be met.

In an advantageous embodiment variant, the shrink tube is a double-walled shrink tube, and a coating of a hot-melt adhesive is arranged on an inner cylindrical surface of the shrink tube. In this respect, it is favourable for the hot-melt adhesive to be able to melt during the shrinking process such that the tube adheres to the metal. Further, during the injection moulding process, the outer layer of the double-walled shrink tube may bond to and embed itself into the injection-moulded parts. This results in an improved sealing effect. In addition, an embodiment is also conceivable in which an outer cylindrical surface of the shrink tube has a coating of an adhesive, in particular a hot-melt adhesive. This creates or increases the adhesion between the outer cylindrical surface of the shrink tube and the plastic overmoulding.

In an exemplary embodiment of the method, it is provided for the shrink tube, before the arrangement step, to be cut to size by means of a cutting device according to the predetermined position of the metal bus bar. In this way, the shrink tube is optimally adapted to the metal bus bar or the predetermined position of the metal bus bar at which the shrink tube is arranged. This reduces an amount of material required and optimizes the sealing effect.

Further, an embodiment is favourable in which, during overmoulding, the metal bus bar and the sealing means are first pre-heated by means of the injection moulding device. For this purpose, the injection moulding device in particular has a heating device. The advantage of this is that the metal bus bar and the sealing means are already brought to an optimum temperature for the overmoulding, thus also improving a fixation of the sealing means.

In a further advantageous variation, the present disclosure provides for, before the arrangement step of the metal bus bar, a marking for the predetermined position of the sealing means to be created on the metal bus bar by means of a marking device. Further, during the arrangement step, the sealing means is arranged according to the marking. In this respect, it is favourable that arranging the sealing means at the predetermined position is facilitated.

In a further preferred embodiment of the method, the arrangement step of the sealing means at the predetermined position of the metal bus bar is performed by means of a handling apparatus or manually. In particular when using a handling apparatus, the method is automatable thereby.

In one embodiment variant, the method according to the present disclosure is performed such that, before the arrangement step, the metal bus bar is cleaned by means of a cleaning device. The advantage of this is that the sealing effect and an adhesion of the sealing means at the predetermined position are optimized.

Another advantage is if, after the overmoulding step, a leak test is performed by means of a corresponding testing device. This can ensure that the sealed bus bar achieves the desired sealing effect.

In an advantageous embodiment variant, the metal bus bar is made of copper or aluminium and/or alloys of copper or aluminium. In a further advantageous variation, it is provided for the plastic overmoulding to be made of polyolefin, polyvinylidene fluoride, Viton, polyvinyl chloride, polyamide (PA), polybutylene terephthalate (PBT), liquid crystal polymers (LCP), polyphthalamide (PPA), polyphenylene sulfide (PPS) and/or polytetrafluoroethylene. These materials are particularly suitable for a sealed bus bar or have positive properties in terms of the sealing effect which supplement each other.

According to the present disclosure, further proposed is a sealed bus bar manufactured by a method according to the above disclosure. The sealed bus bar has a sealing means which is arranged at a predetermined position of the metal bus bar, and a plastic overmoulding, which is arranged around the regions of the sealing means at least such that the sealing means is completely overmoulded.

The features disclosed above can be combined as required, provided this is technically possible and they do not contradict one another.

### BRIEF DESCRIPTION OF THE DRAWINGS

Other advantageous developments of the present disclosure are characterised in the subclaims and/or depicted in greater detail below together with the description of the preferred embodiment of the invention with reference to the figures. In the drawings:

FIG. 1 shows a sectional view of a sealed bus bar, and

FIG. 2 shows a schematic view of a method for manufacturing the sealed bus bar.

The figures are schematic examples. Same reference symbols in the figures indicate same functional and/or structural features.

### DETAILED DESCRIPTION

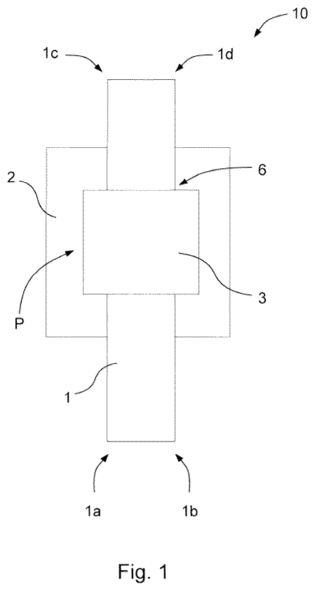

FIG. 1 shows a sealed bus bar 10 with a seal or sealing means 3 which is arranged at a predetermined position P of a metal bus bar 1 and a plastic overmoulding 2 around the regions of the sealing means 3 such that sealing means 3 is completely overmoulded. The sealing means is preferably a compression seal fitting, but may be any known a device or material that helps join systems, mechanisms or other materials together by preventing leakage, containing pressure, or excluding contamination. Metal bus bar 1 has a plurality of bus bar connections 1a, 1b, 1c, 1d. Further, metal bus bar 1 is made of copper or aluminium and/or alloys of copper or aluminium. Moreover, sealing means 3 is a double-walled shrink tube on the inner cylindrical surface of which a coating of hot-melt adhesive is arranged. In addition, an outer cylindrical surface of the shrink tube has a coating of an adhesive. Further, sealing means 3 rests on metal bus bar 1 in a sealing manner. In addition, on metal bus bar 1, a marking 6 for predetermined position P of sealing means 3 is formed on metal bus bar 1. Furthermore, plastic overmoulding 2 is made of polyolefin, polyvinylidene fluoride, Viton, polyvinyl chloride and/or polytetrafluoroethylene.

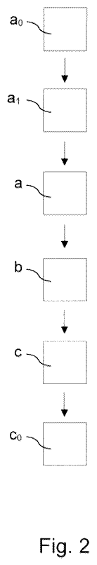

Sealed bus bar 10 shown in FIG. 1 is manufactured by means of the method for manufacturing described below and schematically shown in FIG. 2.

The method for manufacturing sealed bus bar 10 comprises firstly providing a metal bus bar 1 having a plurality of bus bar connections 1a, 1b, 1c, 1d (step a). Then, one or more separate sealing means 3 are arranged at predetermined positions P of bus bar metal 1 (step b), and directly after the arrangement step, metal bus bar 1 is overmoulded with a plastic overmoulding 2 around the regions of sealing means 3 by means of an injection moulding device such that sealing means 3 is completely overmoulded (step c).

In this respect, sealing means 3 is preferably a double-walled shrink tube, wherein, on an inner cylindrical surface of the shrink tube, a coating of hot-melt adhesive is arranged. Further, during overmoulding, the shrink tube is heated by a thermal energy of plastic overmoulding 2, in particular a melt of plastic overmoulding 2, such that the shrink tube shrinks until it rests on metal bus bar 1 in a sealing manner. For this purpose, during overmoulding, metal bus bar 1 and sealing means 3 are optionally first pre-heated by means of the injection moulding device by means of a heating device of the injection moulding device.

In addition, during the method for manufacturing, before the arrangement step, metal bus bar 1 is cleaned by means of a cleaning device (step a0). Then, before the arrangement step, on metal bus bar 1, another marking 6 for predetermined position P of sealing means 3 on metal bus bar 1 is created by means of a marking device (step a1). Afterwards, during the arrangement step, sealing means 3 is arranged according to marking 6. Moreover, the arranging of sealing means 3 at predetermined position P of metal bus bar 1 is performed by means of a handling apparatus.

Furthermore, after the overmoulding step, a leak test is performed by means of a corresponding testing device (step c0).

The present disclosure is not limited in its execution to the above-mentioned preferred exemplary embodiments. Rather, a number of variants are conceivable which make use of the illustrated solution even in the form of fundamentally different embodiments.

1. A method for manufacturing a sealed bus bar, comprising the following steps:
a. providing a metal bus bar having a plurality of bus bar connections;
b. arranging one or more separate seals at predetermined positions of the metal bus bar;
wherein directly after the arrangement step, the following step is performed,
c. overmoulding the metal bus bar with a plastic overmoulding around the positions of the one or more seals by way of an injection moulding device at least such that the one or more seals is completely overmoulded.

2. The method for manufacturing according to claim 1, wherein the one or more seals is a shrink tube, wherein, during the overmoulding, the shrink tube is heated by a thermal energy of the plastic overmoulding, in particular a melt of the plastic overmoulding, such that the shrink tube shrinks until it rests on the metal bus bar in a sealing manner.

3. The method for manufacturing according to claim 2, wherein the shrink tube is a double-walled shrink tube, wherein a coating of a hot-melt adhesive is arranged on an inner cylindrical surface of the shrink tube.

4. The method for manufacturing according to claim 2, wherein, before the arrangement step, the shrink tube is cut to size by means of a cutting device according to the predetermined position of the metal bus bar.

5. The method for manufacturing according to claim 1, wherein, during the overmoulding, the metal bus bar and the one or more seals are pre-heated by means of the injection moulding device.

6. The method for manufacturing according to claim 1, wherein, before the arrangement step, on the metal bus bar, a marking for the predetermined position of the one or more seals on the metal bus bar is created by way of a marking device, wherein, during the arrangement step, the one or more seals is arranged according to the marking.

7. The method for manufacturing according to claim 1, wherein the arranging of the one or more seals at the predetermined position of the metal bus bar is performed by a handling apparatus or manually.

8. The method for manufacturing according to claim 1, wherein, before the arrangement step, the metal bus bar is cleaned by means of a cleaning device.

9. The method for manufacturing according to claim 1, wherein, after the overmoulding step, a leak test is performed by means of a corresponding testing device.

10. The method for manufacturing according to claim 1, wherein the metal bus bar is made of copper or aluminium and/or alloys of copper or aluminium.

11. The method for manufacturing according to claim 1, wherein the plastic overmoulding is made of polyolefin, polyvinylidene fluoride, Viton, polyvinyl chloride, polyamide, polybutylene terephthalate, liquid crystal polymers, polyphthalamide, polyphenylene sulfide and/or polytetrafluorethylene.

12. A sealed bus bar, manufactured by a method according to claim 1, with the one or more seals arranged at a predetermined position of a metal bus bar and a plastic overmoulding around the regions of the one or more seals at least such that the sealing means is completely overmoulded.
